(19) United States
(12) Patent Application Publication
(10) Pub. No.: US 2005/0121400 A1
(43) Pub. Date: Jun. 9, 2005

(54) Multiple parallel layer filter and filtration method

(76) Inventors: Luis Pablo Diaz-Rivera Gonzalez, San Diego, CA (US); Gustavo Adolfo Solis Cortes, San Diego, CA (US)

Correspondence Address: Karl M. Steins;Steins & Associates, Suite 120, 2333 Camino del Rio South, San Diego, CA, 92108, US

(21) Appl. No.: 10/821,709

(22) Filed: Apr. 9, 2004

Related U.S. Application Data
(60) Provisional application No. 60/526,889, filed on Dec. 4, 2003.

(51) Int. Cl. B01D 25/00

(52) U.S. Cl. 210/767; 210/457; 210/488

(57) ABSTRACT

A Multiple Parallel Layer Filter and Filtration Method is disclosed. Also disclosed is a device and method that provides superlative filtration in macro, micro and nano ranges for a variety of fluids. The device uses filtration elements that are relatively low cost, yet provide the significant advantage of being able to be flushed periodically to remove captured solids. The device further employs an arrangement of filter elements wherein the filtration axis of the filters is perpendicular to the flow axis of the collecting housing. Finally, the device and method further provides a way for adjusting filter to capture different sizes of solids, depending upon the particular user adjustment.

This application is filed within one year of, and claims priority to Provisional Application Ser. No. 60/526,889, filed Dec. 4, 2003.

### BACKGROUND OF THE INVENTION

1. Field of the Invention

This invention relates generally to fluid filtration systems and, more specifically, to a Multiple Parallel Layer Filter and Filtration Method

2. Description of Related Art

Filters of many designs and configurations have been used in many fields, and for filtering many fluids, including air, oil, water and many others. Whatever the type of conventional filter, it is normal that they be configured in different filtration sizes in order to obtain different results (and to be used with different fluid viscosities), ranging from nano- and micro- to macro-filtration. As filters begin to trap more and more material, they begin to clog and create a pressure drop as well as to block fluid flow. At some point, just about every type of filter element must be replaced due to this fouling.

There is thus a widely held need to avoid this fouling problem because of the efficiency reductions of the system, as well as to avoid unnecessary replacement costs for new filters.

What is needed, then, is a fluid filtration system and method in which the filtration size is adjustable in order to enable the user to vary the size of the suspended solids being trapped therein. Furthermore, a system that permits cleaning of the filter element(s) without the need for their replacement, is also needed.

### SUMMARY OF THE INVENTION

In light of the aforementioned problems associated with the prior systems and methods, it is an object of the present invention to provide a Multiple Parallel Layer Filter and Filtration Method. The device and method should provide superlative filtration in macro, micro and nano ranges for a variety of fluids. The device should use filtration elements that are relatively low cost, yet provide the significant advantage of being able to be flushed periodically to remove captured solids. The device should employ an arrangement of filter elements wherein the filtration axis of the filters is perpendicular to the flow axis of the collecting housing. The device and method should further provide a way for adjusting filter to capture different sizes of solids, depending upon the particular user adjustment.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG 1 is cutaway side view of the multiple layer parallel filter of the present invention;

FIG. 2 is a perspective view of a filter stack of the filter of FIG. 1;

FIG. 3 is perspective view of the filtering assembly of the invention of FIGS. 1 and 2; and

FIGS. 4A and 4B are graphs depicting the performance characteristics of a filter of the type of the present invention.

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a Multiple Parallel Layer Filter and Filtration Method.

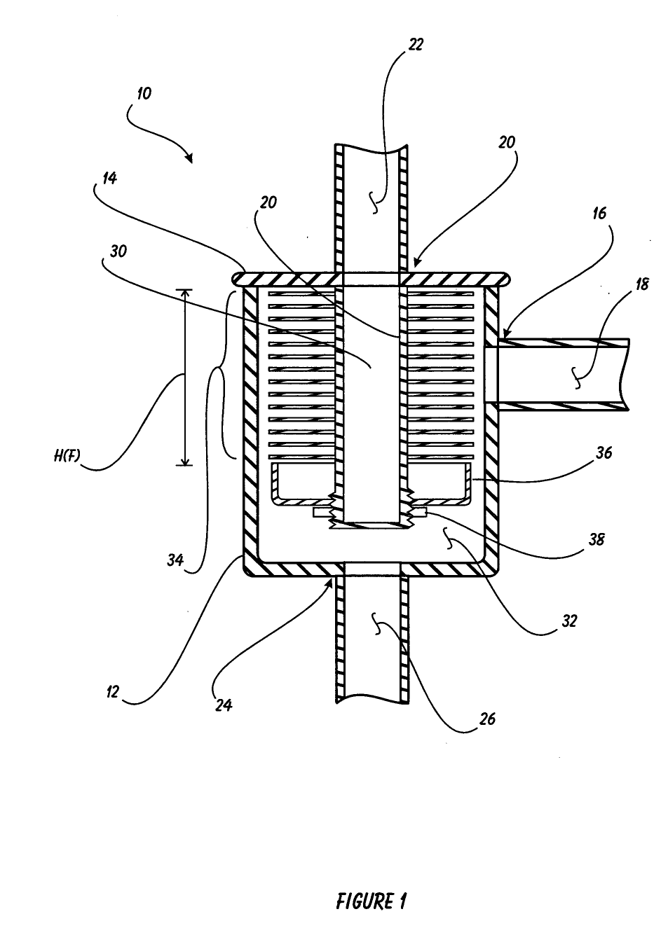

The present invention can best be understood by initial consideration of FIG. 1. FIG. 1 is cutaway side view of a preferred embodiment of the multiple layer parallel filter 10 of the present invention. The filter 10 is an assembly contained within a housing 12 is enclosed by a lid 14 attachable to its upper opening to form a recipient chamber 32 within it. The recipient chamber 32 is in fluid communication with an inlet port 16 and a refuse port 24.

The inlet port 16 allows fluid, such as water to flow through it into the recipient chamber 32 from an inlet duct 18 attached thereto. The inlet duct 18 is a source of non-filtered fluid expected to contained solid matter entrained within it. In a non-depicted version, the inlet duct 18 and inlet port 16 are located excentrically relative to the central axis of the housing 12—such a shape creates a swirling effect for fluid entering the housing 12 which aids in the separation of particulates from the fluid via centrifugal force.

The refuse port 24 allows the waste fluid effluent to exit the recipient chamber 32 and exit through a refuse duct 26. Furthermore, the filter can be back-flushed periodically to remove captured solid matter from the filter media.

Contained within the housing 12 is a novel filter assembly. The assembly is a stack of filter layers 34 that each have a hole in their middle, through which a collector housing 20 passes. A variety of materials may be employed for the layers 34, but it has been demonstrated that “optical” precision filter elements (i.e. very high precision) demonstrate extremely suitable results. The filter layers 34 are held on the collector housing 20 by a compression plate 36. The compression plate or bell 36 may be of a similar planar configuration to the filter layers 34, although it may be slightly larger or smaller in diameter in order to avoid any centering issues. In the depicted version, however, the plate 36 actually has a concave bell shape that causes the upper rim of the plate 36 to be the point of contact between the plate 36 and the filter layers 34—this design has been demonstrated as particularly successful because it creates an outer boundary filtration layer, with an inner core the causes less of a flow restriction. There may be a corresponding rim structure protruding from the lid 14, to aid in creating this boundary layer of filtraton. The compression bell 36 is pressed against the stack of filter layers 34 by an adjustment device 38, such as a conventional nut, bolt or screw. It should be apparent from the arrangement of the elements in the filter assembly that if the adjustment device 38 is tightened or loosened, it will squeeze or release squeezing force against the stack of filter layers 34. By adding compression to the stack of layers 34 (by tightening the adjustment device 38), the filter stack height H(f) will be reduced and the gap between each layer 34 will be reduced. Conversely, if compression is reduced by loosening the adjustment device 38, the filter stack height H(f) will increase due to the gap between each layer 34 increasing.

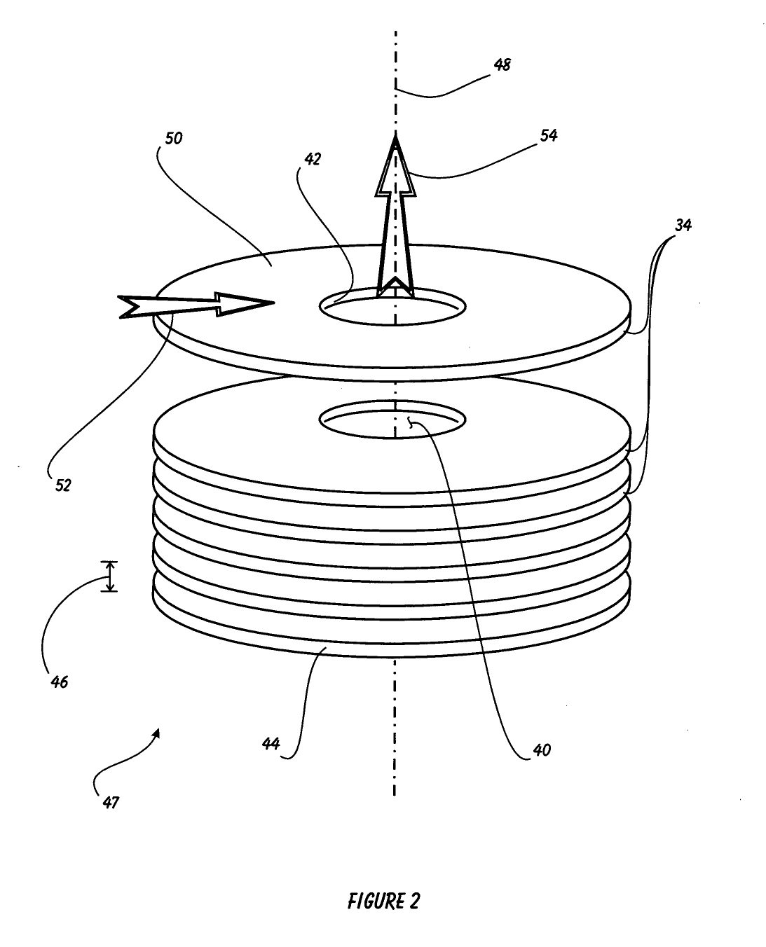

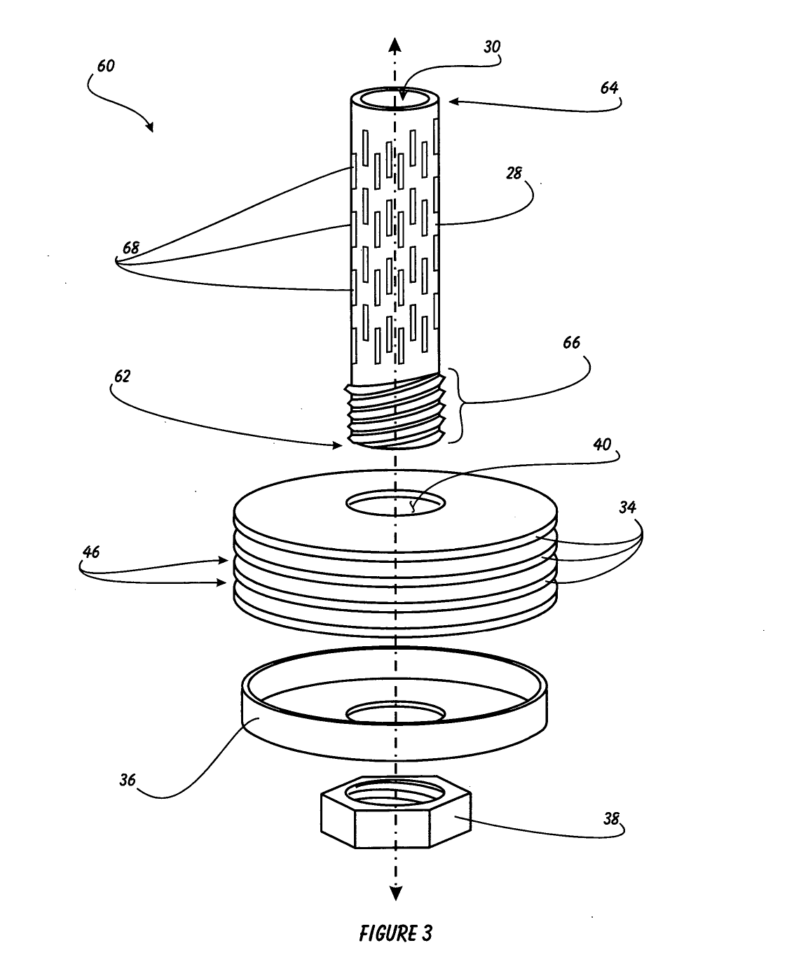

s will be discussed more fully in connection with FIGS. 2 and 3, as fluid passes from the recipient chamber 32 and through the filter layers 34 (horizontally) from the outside of the stack of layers 34 and inward to the collector chamber 30, the fluid will be filtered of the solid matter previously entrained in it, and it will exit the collector chamber 30 through the discharge port 20 and discharge duct 22. Now turning to FIG. 2, we can continue to examine this novel invention.

FIG. 2 is a perspective view of a filter stack 47 of the filter 10 of FIG. 1. The filter layers 34 are shown to be circular rings having an outer periphery 44 and an inner periphery 42 surrounding an inner aperture 40. In other versions of the filter 10, other shapes may be employed for the filter layers 34 (e.g. a square outer periphery and a circular inner periphery, etc.). Where the term “ring-shaped” is used herein, it is intended to describe a structure having an outer periphery and at least one centralized aperture—it is explicitly intended to limit the description to only circular structures.

What is unique about this design is the filtration approach that this invention takes. The fluid flows inward from the outer periphery 44 towards the inner periphery 42 in a direction that is perpendicular 52 to the central axis 48 defined by the collector housing (see FIG. 1). Once inside the collector housing (see FIG. 1), the fluid (now filtered) will follow a parallel flow path 54 (relative to the central axis 48). This approach is very suitable for removing sand from water. The filter layers 34 may be made from a variety of materials and may exhibit a variety of stiffness or rigidity characteristics, depending upon the fluid being filtered and the expected solids that are wished to be removed.

A very unique aspect of this invention is that the spacing 46 or gap between the layers 34 can be adjusted by tightening or loosening the compression plate or compression bell (see FIG. 1). As the spacing 46 is decreased, smaller and smaller-sized solids will be captured as the fluid flows between the layers 34. When the user desires to remove captured solids from the filter stack 47, such as for routine maintenance, it is a simple matter to reduce the compression on the stack 47 by loosening the adjustment device (see FIG. 1) so that the foreign bodies can be back-flushed out through the refuse port (see FIG. 1). Turning, now to FIG. 3, we can review additional detail about other elements of the invention.

FIG. 3 is perspective view of the filtering assembly 60 of the invention of FIGS. 1 and 2. The assembly 60 is a combination of the collector housing 28, the filter layers 34, the compression plate (or bell) 36 and the adjustment device 38. The collector housing 28 is defined by an open top end 64 that connects the housing 28 to the discharge port 20. The housing 28 has a bottom end 62 that has a threaded portion 66 adjacent to it (either external or internal threads). The bottom end 62 is sealed to prevent fluid flow into it. The inners apertures 40 are sized so that the filter layers 34 can be slipped over the collector housing 28. The collector housing 28 further has a plurality of weep apertures 68 dispersed across its wall that allow filtered fluid to pass from the exterior of the collector housing 28 and into the collector chamber 30. The apertures 68 can be slot-shaped as shown, or be other shapes, as desired.

Here, the collector housing 28 and filter layers 34 are shown here to both have circular shapes; it should be understood neither of these elements are confined to these shapes—different shapes might be employed for a variety of applications.

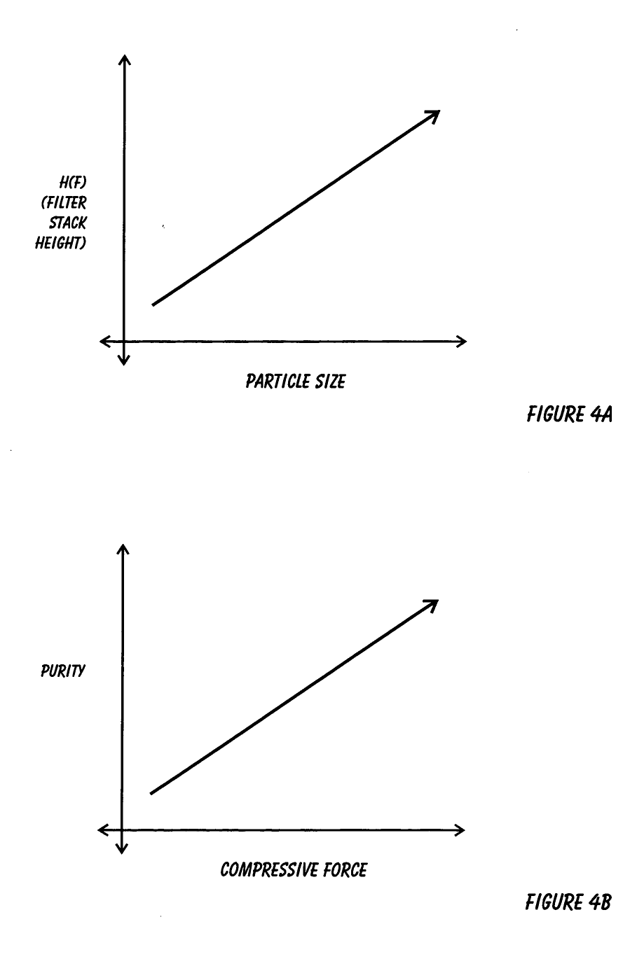

The stack of layers 34 is bounded on its bottom by a compression bell 36; there may be a fixed compression bell at the top of the stack of layers 34 as well. The filter layers 34 and plate 36 are held on the compression housing by an adjustment device 38 that is threadedly engaged with the threaded portion of the collector housing 28. From this drawing it should be apparent that turning the adjustment device 38 will cause the device 38 to travel up and down the threaded portion 66 of the housing 28, and will in turn increase or decrease the compression on the stack of filter layers 34. Finally turning to FIGS. 4A and 4B, we can understand the implications of this novel design.

FIGS. 4A and 4B are graphs depicting the performance characteristics of a filter of the type of the present invention. FIG. 4A represents that as filter stack height H(f) increases, the minimum size of the particles trapped in the filter will increase; as the height. H(f) is decreased, smaller particles will be trapped. Similarly, as shown in FIG. 4B, as compressive force is increased on the filter stack, purity of the discharged (filtered) fluid will be increased as well.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

1. A filter, comprising:
a housing defining a recipient chamber, an inlet port, a discharge port and a refuse port;
a collector housing located within said recipient chamber and defining a top end and a closed bottom end, said top end attached to said discharge port;
a plurality of ring-shaped filter layers, each having a central aperture for accepting said collector housing therethrough; and
a compression plate retaining said filter layers around said collector housing.

2. The filter of claim 1, wherein:
said collector housing defines a central axis; and
said ring-shaped filter layers define generally planar shape and are in closely spaced parallel arrangement in a plane perpendicular to said central axis.

3. The filter of claim 2, wherein said plurality of ring-shaped filter layers define a filter stack having a height in said central axis direction, said filter further comprising an adjustment device for retaining said filter stack and said compression plate to said collector housing.

4. The filter of claim 3, wherein said adjustment device is threadedly engaged with said bottom of said collector housing, whereby rotation of said adjustment device compresses or relieves compression against said compression plate and said filter stack.

5. The filter of claim 4, wherein said filter stack is further defined by flow channels formed between each adjacent pair of said filter layers, said flow channels defined by a horizontal gap in the direction of said central axis, said gap height responsive to rotation of said adjustment device around said collector housing end.

6. The filter of claim 5, wherein said filter layers are rigid.

7. A method for removing entrained solids from a fluid, comprising the steps of:
introducing said fluid having entrained solids into a recipient chamber;
urging said fluid having entrained solids to flow in between ring-shaped planar filter layers;
collecting said fluid in a collector chamber; and
discharging said fluid from said collector chamber.

8. The method of claim 7, wherein said recipient chamber houses said collector chamber.

9. The method of claim 8, wherein said urging comprises urging said fluid having entrained solids to flow from an outer periphery of said ring-shaped planar layers to an inner periphery, said inner periphery adjacent to said collector chamber.

10. The method of claim 9, wherein said collecting comprises collecting said fluid in a tubular collector chamber defining a generally central axis perpendicular to said plane of said layers, said collector chamber having a collector housing defined by a plurality of weep apertures formed therein for accepting said urged fluid therethrough from said filter layers and into said collector chamber.

11. The method of claim 10, further comprising an adjustment step comprising adjusting a retaining plate along said central axis in order to responsively adjust the gaps between each said planar filter layer.

12. The method of claim 11, wherein said adjustment step comprises moving an adjustment device attached to said collector chamber.

13. The method of claim 12, wherein said moving comprises rotating said adjustment device, said adjustment device being threadedly engaged with said collector chamber.

14. A multiple parallel layer filter, comprising:
a tubular collector housing having a top end attached to a lid, a bottom end having a threaded outer surface and defining a generally central axis;
a plurality of planar filter layers arranged around said tubular collector housing to form a stack of said layers rising in the direction of said central axis;
a compression plate having a central aperture formed therein, said collector housing residing through said central aperture;
an adjustment device threadedly engaged to said threaded outer surface to retain said compression plate and said stack about said collector housing; and
a housing and a lid attached thereto cooperatively defining a recipient chamber, said collector housing, said stack, said compression plate and said adjustment device residing in said recipient chamber.

15. The filter of claim 14, further comprising:
an inlet port formed in a side wall of said housing;
a refuse port formed in a bottom wall of said housing; and
a discharge port formed in said lid and in fluid communication with said top of said tubular collector.

16. The filter of claim 15, wherein said stack is defined by a stack height, said stack height dimension being responsive to rotation of said adjustment device.

17. The filter of claim 16, wherein each said layer defines a ring-like shape having a large outer periphery and a smaller inner periphery defining an inner aperture, said inner aperture cooperating with said collector housing to accept said collector housing therethrough.

18. The filter of claim 17, wherein said collector housing is further defined by a plurality of weep apertures between said top and said threaded portion at said bottom.
